(19) United States
(12) Patent Application Publication
(10) Pub. No.: US 2018/0169799 A1
(43) Pub. Date: Jun. 21, 2018

(54) High Strength Weld Metal for Demanding Structural Applications

(71) Applicants: Douglas P. Fairchild, Sugar Land, TX (US); Mario L. Macia, Bellaire, TX (US); Nathan E. Nissley, Houston, TX (US); Raghavan Ayer, Daejeon (KR); Hyun-Woo Jin, Easton, PA (US); Adnan Ozekcin, Bethlehem, PA (US)

(72) Inventors: Douglas P. Fairchild, Sugar Land, TX (US); Mario L. Macia, Bellaire, TX (US); Nathan E. Nissley, Houston, TX (US); Raghavan Ayer, Daejeon (KR); Hyun-Woo Jin, Easton, PA (US); Adnan Ozekcin, Bethlehem, PA (US)

(21) Appl. No.: 15/883,882

(22) Filed: Jan. 30, 2018

Related U.S. Application Data
(62) Division of application No. 14/408,239, filed on Dec. 15, 2014.
(60) Provisional application No. 61/676,738, filed on Jul. 27, 2012.

(51) Int. Cl. B23K 35/30; C22C 38/58; B23K 9/173; C22C 38/44; C22C 38/42; C22C 38/16; C22C 38/14; C22C 38/12; C22C 38/08; C22C 38/04; C22C 38/02; C22C 38/00; B23K 35/38; B23K 9/18; C22C 38/50

(52) U.S. Cl. CPC B23K 35/3066; C22C 38/50; B23K 9/173; C22C 38/44; C22C 38/42; C22C 38/16; C22C 38/14; C22C 38/12; C22C 38/08; C22C 38/04; C22C 38/02; C22C 38/002; C22C 38/00; B23K 35/383; B23K 35/3086; B23K 35/308; B23K 9/186; C22C 38/58

(57) ABSTRACT

Weld metals and methods for welding ferritic steels are provided. The weld metals have high strength and high ductile tearing resistance and are suitable for use in strain based pipelines. The weld metals are comprised of between 0.03 and 0.08 wt % carbon, between 2.0 and 3.5 wt % nickel, not greater than about 2.0 wt % manganese, not greater than about 0.80 wt % molybdenum, not greater than about 0.70 wt % silicon, not greater than about 0.03 wt % aluminum, not greater than 0.02 wt % titanium, not greater than 0.04 wt % zirconium, between 100 and 225 ppm oxygen, not greater than about 100 ppm nitrogen, not greater than about 100 ppm sulfur, not greater than about 100 ppm phosphorus, and the balance essentially iron. The weld metals are applied using a power source with pulsed current waveform control with <5% CO₂ and <2% oxygen in the shielding gas.

### CROSS-REFERENCE TO RELATED APPLICATION

This application claims the priority benefit of U.S. Provisional Patent Application 61/676,738 filed 27 Jul. 2012 entitled HIGH STRENGTH STEEL WELD METAL FOR DEMANDING STRUCTURAL APPLICATIONS, the entirety of which is incorporated by reference herein.

### FIELD OF THE INVENTION

This invention relates to the field of welding metals. More particularly, the invention relates to materials and methods for producing weld metal having high strength and high toughness.

### BACKGROUND

This section introduces various aspects of the art, which may be associated with exemplary embodiments of the present invention. This discussion will assist in providing a framework to facilitate a better understanding of particular aspects of the present invention. This section should be read in this light, and not necessarily as admissions of prior art. In the following specification, the invention is described in the context of strain-based design of pipelines. However, the invention is clearly of wider application to any situation in which a high strength, high toughness weldment is desirable, including but not limited to any non-pipe weldments of any one or more steel materials. Various terms are defined in the following specification. For convenience, a Glossary of terms is provided immediately preceding the claims.

With respect to applied loads, design standards, and material performance requirements, traditional pipelines are designed to prevent the pipeline materials from experiencing significant plastic strains. This type of design is referred to as allowable stress design or stress-based design. In stress-based designs, the applied loads are typically limited to some fraction of the yield strength of the pipe material and the primary design consideration is pressure containment. In some instances, local plasticity might occur in a stress-based-designed pipeline at small stress concentrations like weld toes (i.e., over dimensions of several millimeters), or at the outer fibers of a bend during pipe laying, but generally stress-based designs are not intended for situations where large areas (many inches or feet) of the pipeline are subjected to plastic strains while the pipeline is operating.

Today, pipelines are being designed for increasingly hostile service environments. The goal of pressure containment design is still applicable and relevant to circumferential pipe strength, but some pipelines will also experience service loads in the longitudinal direction. For some demanding environments such as discontinuous permafrost, seismic, iceberg scouring, etc. where service temperatures can range as low as −20° C. or lower, there is a need to design and build pipelines capable of withstanding some degree of longitudinal plastic deformation. In such cases, the deformation is largely oriented parallel to the pipe axis (i.e., longitudinal plastic strains) and the applied loads are often described in terms of applied global strains which are experienced over many inches or possibly feet of pipeline material. Strain-based design (SBD) is the term used to describe designing/constructing a pipeline that is capable of incurring longitudinal plastic strains. Typical strain magnitudes for strain-based designs are generally defined as global plastic strains in excess of 0.5%. Global plastic strains are defined as strains that are not local, but are spread over a distance of many inches or feel as measured along a length of pipe that may include one or more girth welds. In the case of an oil or gas pipeline, for example, global plastic strains for strain-based design purposes could be in reference to a section of the pipeline that is about two pipe diameters in length, although other similar definitions could be used to define global plastic strains. Using this convention, a global plastic strain of one percent in a 30 inch diameter pipeline would produce about 0.6 inches of strain in two diameters of length; i.e., 60 inches in length.

Fracture mechanics techniques called engineering critical assessment (ECA) are used to judge the structural significance of defects in girth welds for stress-based design pipelines. ECA includes accepted practices for testing materials, qualifying welds, and assessing the significance of weld imperfections in stress-based designs. ECA, as applied to stress-based pipelines, is primarily for the purpose of assessing the significance of girth weld defects. In such cases, the girth weld defects may see limited in-service loading in the longitudinal direction and often the most extreme loading occurs during pipeline installation. This typical scenario changes with strain-based design (SBD) because of the more extreme longitudinal in-service loading. Strain-based design is not as mature a field as traditional stress-based design, and as of 2012, fully validated ECA practices for SBD have not been widely accepted by the pipeline industry. However, ECA principles are applicable to SBD. Many aspects of SBD pipeline engineering have been published at recent international conferences. Several notable venues include the Conference of Pipeline Technology in Belgium, the International Pipeline Conference in Canada, and the annual conferences of The International Society of Offshore and Polar Engineers (ISOPE) and The Offshore Mechanics and Arctic Engineering Society (OMAE). ExxonMobil has published numerous articles at these conferences including topics such as prediction methods for girth weld defect tolerance under SBD loading conditions, full-scale pipe testing for SBD engineering, fracture mechanics test methods, and girth welding technology useful in SBD applications. These publications in combination with patent applications International Application Numbers PCT/US2008/001753 (WIPO Patent Application WO/2008/115323, A Framework To Determine The Capacity Of A Structure) and PCT/US2008/001676, (WIPO Patent Application WO/2008/115320, Method To Measure Tearing Resistance) provide the background necessary for strain-based design engineering critical assessment (SBECA) technology to one skilled in the art.

Depending on the service temperature and applied loads, common structural steels and welds can experience either brittle or ductile fracture. Ductile fracture occurs at higher temperatures and brittle (or “cleavage”) fracture occurs at lower temperatures. At some intermediate temperature range, a transition occurs between ductile and brittle fracture. This transition is sometimes characterized by a single temperature called the ductile-to-brittle transition temperature (DBTT). The DBTT can be determined by tests such as the Charpy V-notch or CTOD test, depending on the application.

In stress-based design applications materials engineering and pipeline design practices are focused on ensuring adequate brittle fracture resistance and little attention is paid to ductile fracture of the girth welds. Brittle fracture is mitigated by specifying a minimum design temperature (consistent with the lowest anticipated service temperature) and using test methods like the Charpy V-notch or crack tip opening displacement (CTOD) test to qualify materials.

In the newer application of SBD pipelines, however, it is necessary to go beyond the simple consideration of brittle fracture; ductile fracture of the girth welds must also be considered. Girth welds are usually considered potentially the weakest link due to the common presence of degraded microstructures and imperfections caused by welding. In SBD, the designer, through choice of materials, welding, and inspection technology, will mitigate brittle fracture, or at least delay it until well into the plastic loading regime and beyond the designed strain demand. During plastic loading of a pipeline, ductile tearing can initiate at girth weld discontinuities or defects. Depending on such factors as the strength properties and ductile tearing resistance of the welds, discontinuity or defect size, and pipeline base steel, the amount of tearing can be minimal and stable. If stable, the amount of defect growth typically ranges from a few microns up to a millimeter or two. If this degree of growth can be reliably accounted for in strain-based pipeline engineering practices, and specifically SBECA procedures, then pipeline integrity can be quantified and managed. For these reasons, overmatched girth welds with good ductile tearing resistance are important for SBD pipelines. There is need for weld metals with high strength and high tearing resistance. Special testing techniques are recently available to quantify the tearing properties.

Naturally, there is an inherent tradeoff between strength and toughness in structural steels and weldments. As strength increases, toughness generally decreases. SBD requires both higher strength and higher toughness. A primary challenge for SBD pipelines is how to obtain both high strength and high toughness, particularly tearing resistance, in the girth welds. The properties of pipeline girth welds are primarily controlled by the microstructure, which is in turn controlled by the chemistry and thermal cycle imposed during welding. Chemistry is mostly controlled by the selection of the welding consumables (wire, shielding gas, and/or fluxes) and the chemistry of the base material of the pipe. The weld thermal cycle is primarily a product of the weld procedure and base material thickness.

In the pursuit of high strength, high toughness welds, attempted optimization of properties can result in poor weldability. When conventional welding techniques are combined with new metallurgy the result can be poor weld pool fluidity, arc stability, bead geometry, and penetration profile, all of which can result in weld defects. This is particularly problematic for mechanized 5G pipeline girth welds where the constantly changing weld position and tight bevels creates a challenging situation that demands a welding method that produces good wetting and stable consistent operation. Some consumables cannot be welded out of position for this reason.

One approach to producing steel pipe welds that are useful for strain-based design is disclosed in U.S. Patent Application Publication No. US PA 2010/0089463, published Apr. 15, 2010 (International Patent Application PCT/US2008/001409) which discloses the use of austenitic filler wires to weld pipe for strain-based pipeline designs. The publication teaches the production of high toughness welds using Ni-based alloy, stainless steel, or duplex stainless steel welding consumables. This weld is hereafter called the “austenitic SBD weld”. This publication teaches away from ferritic weld metals in that it states conventional ferritic welds have limitations in toughness and tearing resistance that restrict the amount of strain that can be accommodated in structural design. The below application discloses a ferritic weld that achieves toughness suitable for SBD applications, but is significantly stronger than the austenitic SBD weld.

When austenitic welds are applied to ferritic steels, a dissimilar atomic structure weld interface is created at the boundary between the weld metal and the weld heat affected zone (HAZ). Austenite possesses a face centered cubic (fcc) structure and ferrite possesses a body centered cubic (bcc) structure. Application of ultrasonic testing/inspection to dissimilar interfaces for defects such as lack of fusion can be difficult because this interface produces sound reflections that can be misinterpreted. Fcc and bcc materials have different sound propagation properties and respond differently to ultrasonic inspection. For challenging applications like SBD, it is desired to inspect for small defects with a tolerance on the sizing accuracy on the order of a millimeter. Dissimilar weld interfaces can cause signals during UT inspection that rival the signals created by small defects or at least create uncertainties in sizing accuracy. This is particularly the case for signals that emerge from a dissimilar weld in an area of the heat affected zone that has other geometric complexities like cusps or scallops between adjacent weld beads or in areas where the weld bevel geometry has changed. For the above reasons, it is desirable that ferritic steel pipelines be joined with ferritic welds to avoid dissimilar weld interface and enable accurate inspection when using UT inspection.

U.S. Pat. No. 6,565,678 (the '678 Patent) discloses a ferritic weld metal called acicular ferrite interspersed in martensite (AFIM) that is useful for welding high strength pipelines. The intended application for this weld metal was not SBD pipelines. The '678 Patent provides no consideration of SBD pipelines and the specific requirements of the application herein. As such, the welds of this prior art have no consideration, design, or demonstration of achieving high tearing resistance as is needed for SBD pipelines. No quantification of tearing resistance was made by the '678 Patent as would be needed for SBECA as described by literature sources noted above. Furthermore, because the '678 Patent makes no consideration of tearing resistance, it therefore makes no consideration of the welding techniques required to produce welds optimum for SBD. This includes use of special shielding gas mixtures and the resultant need for highly specialized pulsed waveform power supplies that have only become available after the invention date of the '678 Patent.

The utility of oxygen and acicular ferrite in weld metal are discussed by the '678 Patent; however, there is no attention paid to optimizing these components for SBD welds. The '678 Patent states, “For a particular application, the welding engineer can control the acicular ferrite content and the oxygen level by choices of weld metal chemistry, shielding gas composition, and welding procedure (weld cooling rates) according to the guidelines of this invention”. There is no mention of the use of advanced pulsed waveform power supplies to optimize an AFIM microstructure for SBD. The consideration of such power supplies would naturally fall in the category of welding procedure, but the lack of consideration of such by '678 Patent is understandable because advanced waveform power supplies were not available at the '678 Patent was filed.

The '678 Patent discusses the importance of weld metal inclusions in high strength weld metal. The '678 Patent seeks to produce a large number of small inclusions in order to nucleate acicular ferrite. This objective is suitable for conventional high strength stress based pipelines design where ductile tearing resistance isn't a primary concern, but the same approach would not be suitable for SBD pipeline welds. Due to the need for high tearing resistance, SBD pipeline welds require a lower number of weld metal inclusions as compared to stress based design welds and this has been discussed in D. P. Fairchild, et al, “Girth Welds for Strain-Based Design Pipelines”, Proceeding of the 18^{th} International ISOPE Conference, Vancouver, 2008.

There is a need for weld metal that simultaneously produces high strength, high ductile tearing resistance, and good brittle fracture resistance (i.e., good ductile and brittle fracture toughness) and that can be applied during pipeline field construction without undue concern regarding weldability or ease of use in terms of weld pool control and defect rates.

### SUMMARY

The present invention provides a novel weld metal that achieves high strength welds with superior ductile tearing resistance and good weldability.

One embodiment of the present disclosure is a weld metal which comprises between 0.03 and 0.08 wt % carbon, between 2.0 and 3.5 wt % nickel, not greater than about 2.00 wt % manganese, not greater than about 0.8 wt % molybdenum, not greater than about 0.70 wt % silicon, not greater than about 0.03 wt % aluminum, not greater than about 0.02 wt % Ti, not greater than about 0.04 wt % Zr, between 100 and 225 ppm oxygen, not greater than about 100 ppm sulfur, not greater than about 100 ppm phosphorus, not greater than about 100 ppm nitrogen, and the balance essentially iron, wherein the weld metal comprises an SBD-AFIM microstructure, the weld metal is applied using a pulsed gas metal arc welding process with an advanced pulsed waveform power supply and utilizes a shielding gas comprised of less than 5% CO₂ and less than 2% O₂, the applied weld metal has a tensile strength of greater than 90 ksi and a SENT R-curve delta value of greater than 0.75.

In other embodiments of the present disclosure, elements that may be added to enhance weld metal properties comprise: not greater than about 0.6 wt % copper, not greater than about 0.04 wt % vanadium, not greater than about 0.60 wt % Cr, not greater than about 0.04 wt % Nb, not greater than about 20 ppm B. The carbon content and other alloys of the weld metal may be adjusted within the range to provide welds with sufficient strength for SBD applications with pipe grades X52 to X100 or higher.

The foregoing has broadly outlined the features of some embodiments of the present disclosure in order that the detailed description that follows may be better understood. Additional features and embodiments will also be described herein.

### DESCRIPTION OF THE DRAWINGS

The present invention and its advantages will be better understood by referring to the following detailed description and the attached drawings.

FIG. 1 is a graph of Pcm versus weld metal ultimate tensile strength for a range of compositions of the SBD-AFIM weld metal according to one embodiment of the present disclosure and that of the AFIM weld metal disclosed in U.S. Pat. No. 6,565,678.

FIG. 2 is a cross sectional drawing of a CRC bevel.

FIG. 3 is a cross sectional drawing of a high strain weld according to one embodiment of the present disclosure.

FIG. 4 is a flowchart of a method of welding ferritic steel pipelines according to one embodiment of the present disclosure.

FIG. 5 is a plot of an embodiment of a GMAW pulse waveform useful in applying an embodiment of the SBD AFIM weld metals.

FIG. 6 is an optical macro image of a cross-section of an embodiment of a SBD-AFIM weld illustrating weld fusion defects.

FIG. 7 is a drawing of a SENT specimen used to generate data for an R-curve.

FIG. 8 is a graph of an example R-curve.

FIG. 9 is a graph of hypothetical R-curves for a low toughness X70 girth weld and two example high toughness HSWs according to embodiments of the present disclosure.

FIG. 10 is a schematic drawing of the SBD-AFIM microstructure of the weld metal of an embodiment of the present disclosure.

FIG. 11 is an optical macro image of an example HSW.

FIG. 12 is an optical micrograph of the microstructure of one embodiment of HSW showing SBD-AFIM.

FIG. 13 is a scanning electron micrograph showing one embodiment of SBD-AFIM microstructure.

FIG. 14 is a transmission electron micrograph showing acicular ferrite and several inclusions, a common component of the SBD-AFIM microstructure.

FIGS. 15 and 16 are transmission electron micrographs of degenerate upper bainite showing several parallel laths and discontinuous MA at lath boundaries. DUB is a common component of the SBD-AFIM microstructure.

FIG. 17 is a transmission electron micrograph of granular bainite showing multiple grains of bainitic ferrite and scattered MA particles.

FIG. 18 is a transmission electron micrograph of lath martensite showing parallel dislocated laths and no MA at the lath boundaries.

FIG. 19 is a graph of Charpy V-notch (CVN) data showing the effect of CO₂ content in the shielding gas.

FIG. 20 is a photo of a full-scale pipe strain test failure location showing pipe collapse away from the girth weld.

It should be noted that the figures are merely examples of several embodiments of the present invention and no limitations on the scope of the present invention are intended thereby. Further, the figures are generally not drawn to scale, but are drafted for purposes of convenience and clarity in illustrating various aspects of certain embodiments of the invention.

### DETAILED DESCRIPTION OF THE INVENTION

In the following detailed description section, the specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. The invention is not limited to the specific embodiments described below, but rather, it includes all alternatives, modifications, and equivalents falling within the spirit and scope of the appended claims.

The weld metal of the present disclosure may be referred to as strain-based design, acicular ferrite interspersed in martensite weld metal or SBD-AFIM. Also, when referring to welds containing this microstructure, the term high strain welds (HSWs) is sometimes used.

An embodiment of the present disclosure comprises a ferritic weld metal that is applied using a modern gas metal arc welding (GMAW) process with power source current waveform control sufficient to adequately produce a smooth, controlled welding arc and weld pool when low quantities of CO₂ (<5%) and oxygen (<2%) are used in the shielding gas. This produces a ferritic microstructure useful for SBD pipeline girth welds that are capable of simultaneously achieving high strength, good low temperature toughness, excellent ductile tearing resistance and welds with low defect rates. Embodiments of the present disclosure obtain good weldability which refers to a group of attributes including good weld pool fluidity, arc stability (“smooth” arc), good wetting of the weld pool at the junction with the base metal, and good bead penetration geometry, all of which are aimed at reducing weld defects.

Embodiments of the weld metal discussed in the present disclosure produce adequate strength and toughness for girth welds in strain-based design pipelines. These novel welds are suitable for SBD pipelines in a variety pipe grades, such as, but not limited to, X52, X60, X65, X70, X80, X90, X100 and potentially X120 and these welds can be applied during field construction with acceptable weldability and defect rates. The weld metal desired for a particular application is designed through choice of the weld metal chemistry and the welding method (process and procedure, including power source type and shielding gas selection) and can be applied in conditions of rugged field pipeline construction to produce suitable weld microstructure and mechanical properties.

In one embodiment, a weld metal comprises: between 0.03 and 0.08 wt % carbon, between 2.0 and 3.5 wt % nickel, not greater than about 2.0 wt % manganese, not greater than about 0.80 wt % molybdenum, not greater than about 0.70 wt % silicon, not greater than about 0.03 wt % aluminum, not greater than 0.02 wt % titanium, not greater than 0.04 wt % zirconium, between 100 and 225 ppm oxygen, not greater than about 100 ppm nitrogen, not greater than about 100 ppm sulfur, not greater than about 100 ppm phosphorus, and the balance is iron.

While the balance of the weld metal composition is iron, it is possible the weld metal may include other unlisted components, for example impurities or the like.

Other elements may be added for the reasons discussed in further detail below: not greater than about 0.6 wt % copper, not greater than about 0.04 wt % vanadium, and not greater than 0.6 wt % chromium, not greater than about 0.04 wt % Nb, not greater than about 20 ppm B. All percentages herein relating to composition of the weld metal are expressed in wt % (weight percent).

Carbon is added to the chemistry as the primary strength controlling element. Mn contributes solid solution strengthening and general hardenability, but also acts as a deoxidizer. Ni is added for its positive influence on toughness. It also contributes to solid solution strengthening and hardenability. Mo, Cu, and Cr can be added to boost strength in the solid solution and through hardenability. Si is added as a deoxidizer and to improve weld pool fluidity, which helps prevent weld defects. However, Si also degrades toughness through the formation of oxide inclusions. Therefore, depending on the tradeoff between toughness and weldability, Si can be optimized by the user.

Ti and Zr combine primarily with oxygen in the molten weld pool, forming small oxides that pin prior austenite grain boundaries and reduce grain size during cooling from high welding temperatures. Ti and Zr have a high affinity for oxygen and combine with oxygen at high temperatures promoting the formation of very small inclusion nuclei. This promotes the formation of small, finely dispersed oxides in the weld metal.

Oxygen is controlled to a great degree by the welding shielding gas composition (weldability enabled by special power sources as explained below) when the HSWs are applied with a gas shielded process. For example, it would be typical to weld the HSWs with a shielding gas mixture comprised of Ar, He, and 1 to 4% CO₂ (or 0.5 to 2% O₂). The weld metal oxygen content of embodiment of the present disclosure balance (1) the need to reduce non-metallic inclusions in the weld metal to maximize tearing resistance, and (2) producing a sufficient distribution of inclusions for the nucleation of acicular ferrite (AF). Efforts to consistently control oxygen also include cleaning of the weld bevel (no rust or oily contaminants) and keeping the welding wire stored and covered to prevent moisture or rust deposits on the wire. In general, the HSWs are applied using a welding process that controls oxygen in the welding environment in order to produce optimized and consistent oxygen levels in the weld pool.

V and Nb can be added for precipitation strengthening additions. They combine with carbon and/or nitrogen to form small carbides, nitrides, or carbonitrides in the weld as a result of multipass welding. V and Nb can also contribute a small amount to hardenability and strength. Boron is a powerful strengthening agent. It can be added to boost strength through interstitial strengthening and hardenability.

Sulfur and phosphorus are impurities and are not intentionally added. Efforts are made to limit these elements in the weld. Sulfur and phosphorus can be controlled by limiting their amount in the weld consumable wire. The limits listed above for the weld metal are also suitable limits for the welding wire.

Nitrogen is also present as an impurity and typically is present in the weld metal as a result of atmospheric absorption during the welding process due to insufficient shielding coverage. Nitrogen can also be transferred from the weld wire or base metal dilution. Nitrogen can cause porosity or degraded toughness and its amount must be limited. The limits listed above for the weld metal are also suitable for the welding wire.

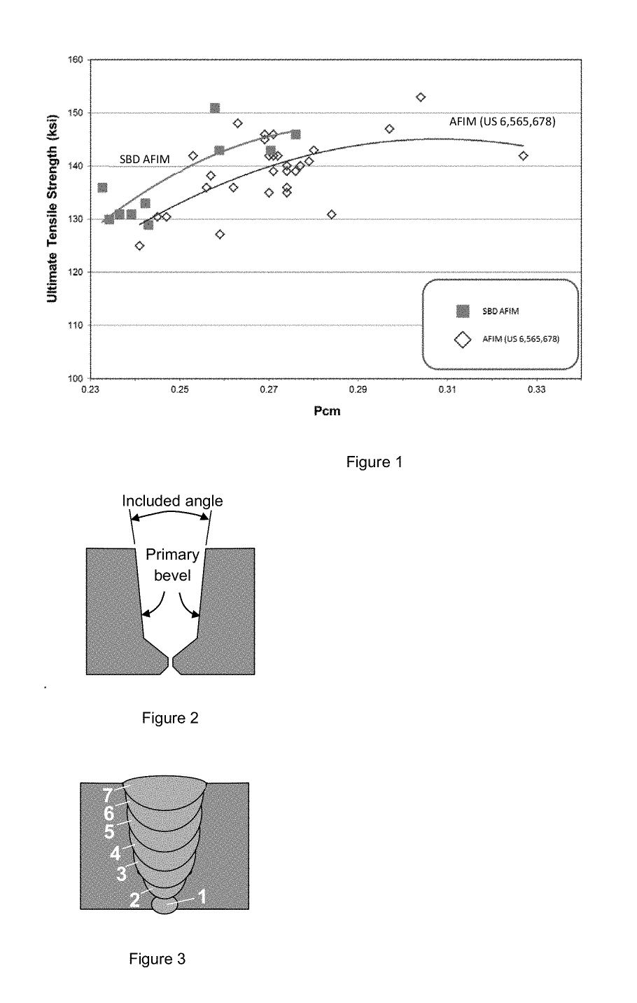

Depending on application and the required weld strength, the weld metal composition can be adjusted within the noted ranges to suit pipeline grades from X52 to X120. A wide variety of base metal tensile strengths can be accommodated from about 60 ksi to about 130 ksi. The carbon content is most influential for adjusting strength, although other alloys can provide some strength adjustments as well. Lower strengths are achieved with carbon contents of about 0.03 wt % while the highest strengths are obtained with carbon contents of about 0.08 wt %. By adjustment of carbon and other alloys, tensile strengths up to about 150 ksi are possible. FIG. 1 shows a graph of Pcm versus weld tensile strength (UTS) for a range of compositions of the novel weld metal. The same trend for U.S. Pat. No. 6,565,678 is also included in this figure for comparison. Pcm is a hardenability measure that can be used to predict strength and the user can adjust chemistry according to this Pcm data to select a HSW for a particular application. As is known to those skilled in the art of welding engineering, Pcm can be calculated based on a known chemical composition.

High toughness is achievable by the HSWs, even for the highest strengths versions of embodiments of the present disclosure. Upper shelf Charpy energy and good CTOD (crack tip opening displacement) toughness can be achieved down to about −40° C.

Due to the low solubility of oxygen in steel welds, non-metallic inclusions are an important aspect of the metallurgical design. Whereas conventional pipeline welds are typically produced with large populations of weld metal inclusions, the HSWs are designed to control and optimize the type, size, and density of inclusions. In general, excessive weld metal inclusions degrade both the brittle and ductile fracture toughness of the HSWs microstructures provided. These inclusions act as preferential nucleation locations for both brittle and ductile fracture. Specifically, for ductile fracture, they provide microvoid nucleation sites and reduce the energy needed for ductile tearing. However, in the SBD-AFIM microstructure, the inclusion volume fraction and size distribution is optimized to achieve high tearing resistance.

The microstructure of the SBD-AFIM weld deposit is similar to that described in U.S. Pat. No. 6,565,678 (the '678 Patent), but important differences exist. For the purposes of optimizing a weld for SBD, it has been discovered that while the AFIM weld metal of the '678 Patent provides a good starting point, this weld metal is populated with more weld metal inclusions than are required to nucleate the required volume fraction of acicular ferrite. The inventors have therefore designed SBD-AFIM weld metals with lower inclusion content to increase ductile tearing resistance. This has been accomplished by using shielding gases with lower CO₂ content. Whereas the AFIM weld metals of the '678 Patent would typically be produced with 5%, 10%, or 15% CO₂, the SBD-AFIM welds are produced with <5% CO₂. This produces lower oxygen content and fewer inclusions. The decision to use less than 5% CO₂ in the shielding gas of SBD-AFIM welds is a key inventive step. This helps generate a weld with both high brittle and ductile fracture resistance.

The use of <5% CO₂ in the HSWs has drawbacks that the inventors have mitigated. The lower inclusion content that comes with <5% CO₂ decreases the potential to nucleate acicular ferrite. Because acicular ferrite is very important for the SBD-AFIM microstructure, the preferred carbon and total alloy content is reduced compared to the AFIM welds of the '678 Patent. This increases the driving force for acicular ferrite which can offset the lower potential to nucleate acicular ferrite off of fewer inclusions. A minimum amount of acicular ferrite is necessary in the SBD-AFIM weld metals to achieve adequate toughness. It is desirable to produce at least 15% acicular ferrite in the SBD-AFIM welds. Since ductile tearing resistance is desired for the SBD-AFIM welds, ideally the welds should contain 20 to 30% acicular ferrite. Admittedly, the SBD-AFIM microstructure, due to the reduced alloy content, has less strength making potential compared to the AFIM microstructure of the '678 Patent. This tendency for lower strength is mostly with regard to yield strength potential rather than ultimate tensile strength and the SBD-AFIM microstructure can still be used for SBD applications where overmatching tensile strength is a primary goal.

The SBD-AFIM weld metal chemistry can, in combination with the base metal chemistry, be used to calculate the necessary consumable weld wire composition. The SBD-AFIM chemistry can be applied to a wide variety of base metals simply by alteration of the weld wire chemistry and knowledge of the welding process that controls the amount of penetration and base metal dilution. As is known to those skilled in the art of welding engineering, dilution calculations can be used to determine one of three chemistries when two of the chemistries are known or specified. In the case of welding structural steels, there are three metals involved; the base metal, the weld metal, and the filler wire. For the application of 5G mechanized pipeline girth welding, dilution is typically 10% to 20% for the majority of the weld passes. Dilution calculations are known in the art and are explained in a number of welding engineering textbooks including Welding Metallurgy, Volume 2, Third Edition, by George E. Linnert that was published by The American Welding Society.

The two primary steps to producing the SBD-AFIM welds according to embodiments of the present disclosure are (1) optimizing weld metal oxygen content and (2) limiting weld defects that might result from welding with lower levels of CO₂ or O₂ in the shielding gas. Controlling oxygen content is an important objective because, as described above, the weld metal needs non-metallic inclusion to nucleate acicular ferrite, but excessive inclusions lead to degraded ductile tearing resistance. Optimizing oxygen content is accomplished by limiting the oxygen potential of the shielding gas (CO₂ or O₂); however, this choice has a downside. Lowering the oxygen potential, if otherwise not addressed, results in poor weldability. In particular, <5% CO₂ in a shielding gas used for mechanized 5G pipeline welding would typically result in poor weld pool fluidity, arc stability, bead geometry including penetration profile, all of which can result in weld defects. This condition is responsible for the second inventive step for SBD-AFIM welds; limiting defects in light of the necessary shielding gases.

Because shielding gases with low oxygen potential are chosen for SBD-AFIM welds, the weld metal is more viscous when molten and does not flow or wet as well as typical pipeline weld metals. The poor weldability makes it difficult to produce smooth transitions between the weld edges and the base metal. This is often associated with high surface tension (high viscosity) whereby the junction between the weld metal and base metal is characterized by a sharp angle sometimes referred to as a reentrant angle. These regions (also called the weld toes) can be the location of lack of fusion defects or they can be trapping sites for silicates that have floated to the top of the weld pool. This situation can also be characterized by welds that are “crowned” which refer to a highly convex weld bead profile.

In addition to the fluidity problem, the welding arc can be less stable with reduced CO₂ in the shielding gas. The arc can sputter and wander to a greater degree and is generally cooler than an arc with higher CO₂. These aspects also increase the likelihood of weld defects.

A typical welding solution used to improve the aforementioned weldability challenges would be to use welding shielding gases containing more CO₂ or oxygen. These gases reduce the surface tension of the weld metal and smooth out the molten weld pool. These gases also produce better arc stability which has the effect of creating a smoother weld pool and better weldability. For the HSWs, using more CO₂ or oxygen is not an option because this increases inclusions and decreases toughness and ductile tearing resistance.

One method for applying the HSWs is using low CO₂ or oxygen in the shielding gas and this generally means using a higher amount of argon. Welds made with high levels of argon tend to have a narrower “finger” penetration bead profile and this increases the likelihood of weld defects. Helium can be substituted for some of the argon to reduce the finger penetration bead profile, but helium also tends to lead to more arc instability which increases the potential for defects. Therefore, another weldability challenge for the HSWs is that of preventing excessive finger penetration.

The two inventive steps key to applying the HSWs can be accomplished with recently developed welding technology. One embodiment of the present disclosure utilizes recent advancements in the electronic control of gas metal arc welding (GMAW) machines to enable effective application of the HSWs2. The GMAW process is a typical choice for field pipeline welding because it is rugged and efficient; however, traditional GMAW equipment requires the shielding gas contain a significant quantity of either CO₂ or oxygen to achieve good weldability, i.e., good weld pool fluidity, arc stability, bead geometry, and low defect rates.

GMAW welding machines have recently become available that enable smooth welding (good weldability) of the HSWs with limited amounts of CO₂ or oxygen in the shielding gas. Using sophisticated solid state electronics, some manufacturers of GMAW power sources have recently incorporated advanced pulsed waveform control to optimize and improve weldability. This type of welding is generically referred to as pulsed GMAW or PGMAW. The American Welding Society has designated this process as GMAW-P. Although PGMAW machines have been in existence for many years, only recently have waveform controls in these machines become advanced enough to enable HSWs with the SBD-AFIM microstructure. The inventors have determined that the newer pulsed waveform welding machines, and particularly those manufactured after about 2003, enable low oxygen content and reduced defect potential in spite of the difficulties that would normally accompany a low oxygen potential shielding gas.

For mechanized pipeline girth welding in which the welding head orbits around the circumference of the pipes being joined, the HSWs can be deposited in a narrow groove bevel preparation, a weld design known to those skilled in the art of structural or pipeline welding. Narrow bevels may be of a single or compound bevel design whereby the primary bevel is typically of an included angle from about 0° to about 20°. One common pipeline bevel design is shown in FIG. 2, which is sometimes called a CRC bevel, a design pioneered by CRC Evans Automatic Welding, which illustrates the included angle and the primary bevel surfaces.

The novel HSW microstructure can also be deposited in an “open” weld bevel as known to those skilled in the art of structural or pipeline welding. Open bevels can have included angles from about 20° up to about 60°. Open bevels are often used for tie-in welds, repair welds, and insertion of replacement pipe sections. The HSW microstructure can also be deposited as a fillet weld or any other weld configuration depending on the application.

FIG. 3 is a schematic cross section of an embodiment of the HSW produced using seven passes. Depending on the application, HSW technology can be used for all weld passes or for only some weld passes; if the resultant weld achieves a desired high strain capacity, it can be termed a HSW. For example, mechanized pipeline welds are sometimes made where the root pass (pass #1 in FIG. 3) is deposited from the inside of the pipe using an internal welding machine. This internal weld bead is typically very small. In one embodiment of a HSW, the internal root pass can be applied using a conventional welding wire and procedure while the remainder of the passes are applied using the SBD-AFIM consumable wire and chemistry. It can be advantageous to apply the first two passes (root and hot pass) using conventional technology to reduce the risk of root defects, and then apply the remaining passes with the HSWs to produce the SBD-AFIM chemistry. An advantage of a HSW is the combination of strength and toughness properties, so depending on the specific structural application and constraints regarding economic construction scenarios, HSWs can be applied in a variety of ways to suit the intended purpose.

### Welding Process and Procedure Using GMAW

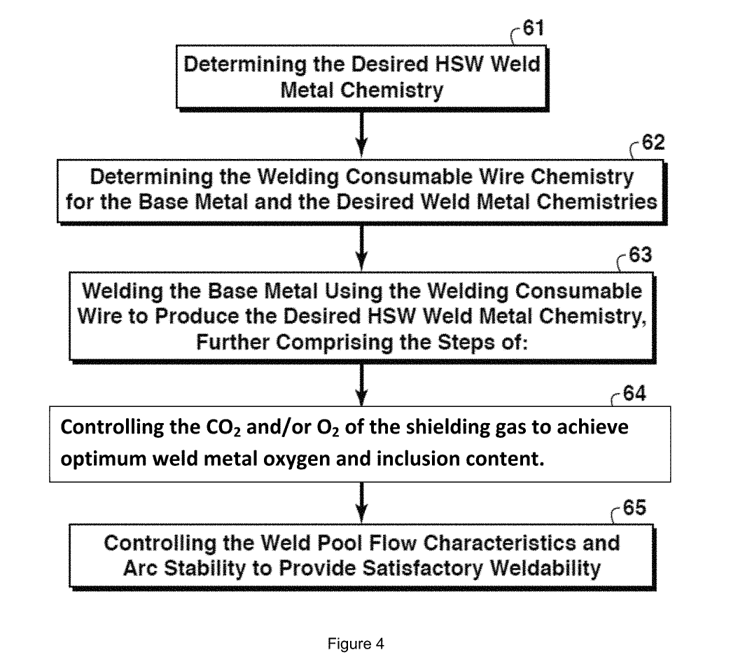

One embodiment of the present disclosure comprises a method of producing HSWs for given design conditions. With reference to FIG. 4, the method comprises determining the desired HSW weld metal chemistry 61 within the effective ranges disclosed herein. The method also includes the step of determining the welding consumable wire chemistry given the base metal chemistry and the desired weld metal chemistry 62. This step may comprise performing dilution calculations as discussed previously. The method further comprises welding the base metal using the welding consumable wire 63, including the step of providing means for controlling the weld pool oxygen and inclusion content during welding to achieve a target weld metal oxygen content and inclusion content 64 and the step of controlling the arc stability and weld pool flow characteristics during welding to provide satisfactory weldability and weld fusion 65. The step of controlling the weld pool oxygen content may comprise cleaning or shielding the weld from elemental oxygen as well as other oxygen-containing compounds and may include providing a low-oxygen welding shielding gas or flux. Low oxygen shielding gas means less than 5% CO₂ and less than 2% oxygen depending if CO₂ or oxygen is contained in the shielding gas. Low oxygen flux can be defined, as explained below, through a basicity index as is known to those skilled in the art of welding engineering. The step of controlling the arc stability, weld pool flow characteristics, and bead geometry may comprise use of a modern pulsed power supply GMAW welding machine with current waveform control adjusted to permit acceptable weldability of the HSW. This step may include other welding apparatus and techniques such as provided below.

For field pipeline construction, the HSWs are preferably made using the GMAW-based processes, and particularly PGMAW, although other processes can be used provided that the specified chemistry and microstructure are achieved and the weldability and defect potential (sizes and rate) are satisfactory for the application. Due to the sensitivity of the HSWs to weld metal oxygen content and non-metallic inclusions, a preferred welding technique for achieving the highest levels of toughness with HSWs is to use a shielding gas composition consisting of mixtures of argon (Ar), helium (He), and carbon dioxide (CO₂) or oxygen (O₂). Typical gas compositions range between 7 and 35% He, 1 and 4% CO₂ (or 0.5 and 2% O₂) with the balance Ar. Higher percentages of He are useful for out-of-position welding and improved wetting and good bead penetration profile. This must be balanced with the tendency of He (being a light gas) to be easily swept away by wind currents during outdoor welding. This can be managed by using protective welding enclosures if necessary. Additionally, additions of He can increase variability in the arc voltage which can lead to arc instability; however, this can be mitigated, as provided herein, by adjustment of the power supply and coordination with the characteristics of the welding head.

Advanced pulsed welding power supplies are important for achieving the HSW microstructure and achieving good weldability during field construction. Several examples of these power supplies are the Fronius TransPulse Synergic 5000, the Lincoln Power Wave 455, and the Miller PipePro 450.

A system for applying the HSWs to 5G girth welds in an embodiment of the present disclosure includes the use of background currents of about 100 to 175 amps and pulse current magnitudes of about 475 to about 575 amps. Arc voltage typically ranges from about 16V to about 25V. Wire feed speeds range from about 275 ipm to about 575 ipm for 0.9 mm diameter wire. Shielding gas flow rates range from about 30 to about 80 cfh. Travel speeds range from about 25 ipm to about 50 ipm for root and hot pass welding. Travel speeds range from about 10 ipm to about 25 ipm for the fill passes and about 8 ipm to about 15 ipm for the cap pass. Filler wire diameters can range from 0.8 mm to about 1.4 mm. Heat inputs range from about 0.2 kJ/mm to about 0.5 kJ/mm for the root and hot pass and from about 0.4 kJ/mm to about 1.4 kJ/mm for the fill and cap passes. One skilled in the art of PGMAW can adjust the pulsing parameters to obtain the desired welding arc and weld pool that will suppress the weldability issues associated with low oxygen potential shielding gas. This adjustment can be accomplished without resorting to the addition of excessive CO₂ or oxygen to the shielding gas as is typically practiced for pipeline girth welding.

As with all situations of weld procedure development when a new or challenging wire is involved, some experimentation is necessary to optimize weldability and to limit defect rate. Because many permutations are possible in combining welding variables, and because each welding scenario will involve different conditions of base metal thickness, bevel geometry, and weld position, it is not practical to prescribe one set of welding parameters that will be suitable for all applications of HSWs. Routine improvements in weldability can be made by manipulation of the wire feed speed, travel speed, shielding gas composition, torch oscillation, and general arc parameters like background current. Additional improvements are enabled with modern power sources by adjustment of the pulsing parameters. This includes, but is not limited to, adjustment of the following variables: pulse frequency, pulse magnitude, pulse width, and pulse shape. Due to the rapid response time of the modern electronics used for waveform control power supplies, fine adjustments of the pulsing shape can be made including the shape of pulse ramp up (current rise), peak pulse current, pulsing current time, overshoot, the shape during ramp down, tail-out speed, droplet detachment time, step-off current, droplet detachment current, short circuit current rise, and the pulse period (frequency). Producing variations such as combining a series of different pulses is also possible. Additionally, combining these power source adjustments with the electronics, motion, or other characteristics of the welding head are also possible.

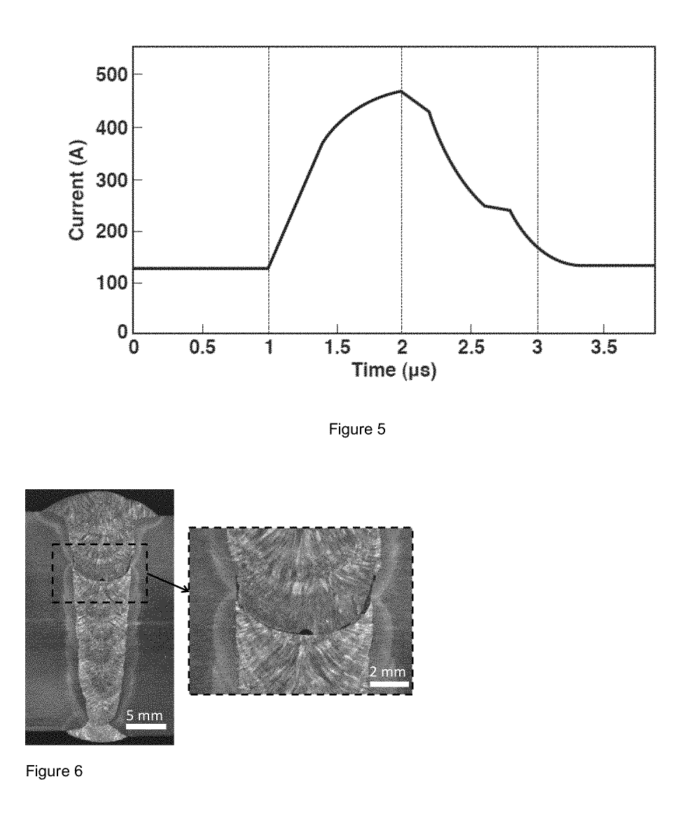

The product literature that accompanies modern waveform control power supplies contains guidance on how to make pulsing adjustments to enable specific arc characteristics and weld pool control. Pulsing adjustments can be used to modify the transfer mode, the droplet size, the droplet frequency, and to modify such factors as the turbulence of the weld pool, the weld contour, weld penetration, and the ability of the weld pool to wet smoothly into the base metal. In other words, pulsing adjustments can be used to improve weldability. The pulsing adjustments can also be used to reduce weld spatter. It is an expected and natural step during weld procedure development to adjust these parameters to improve weldability. FIG. 5 illustrates a pulse waveform generated by the inventors that is useful in applying an embodiment of the SBD-AFIM weld metals.

Obtaining the best combination of mechanical properties for any given HSW geometry and wire combination can be optimized by adjusting the amount of oxygen in the weld deposit. The inventors have determined that very low CO₂ (<1%) in the shielding gas will result in higher strength welds with poor brittle fracture resistance. Optimal levels of CO₂ (typically 1-4%) produce welds with high strength and good toughness (both brittle and ductile fracture resistance). Welds made with higher levels of CO₂ (>4%) have lower strength and lower ductile fracture resistance compared to the preferred SBD-AFIM welds.

### Weld Pool Agitation

Weld pool agitation is another technique that can be used to mitigate or control the weld pool flow characteristics and bead penetration profile of the HSWs. Mechanical or ultrasonic vibration can be applied directly to the consumable wire or through an independent ceramic rod that contacts the molten weld pool. Weld pool agitation has a similar effect of reducing the surface tension of the weld pool which enables better weldability. Depending on the user's capabilities, welding equipment, and fabrication scenario, the agitation technique can be applied either in addition to, or in lieu of, using an advance waveform power supply.

### Weld Defects

The HSWs are enabled by use of low oxygen potential shielding gases and the pitfalls of these shielding gases are mitigated through use of modern power supplies. These inventive steps enable mechanized 5G pipeline welds, and even semi-automatic pipeline welds, to be made with good weldability including good weld pool fluidity, bead geometry, arc stability and acceptable defect rates. If the HSWs are attempted without due attention to optimizing shielding gas and power source control as described herein, then the welding defect shown in FIG. 6 can occur in sizes or rates that are unacceptable for efficient pipeline construction. Typically, it is desirable to keep reject rates due to these defects below about 5% during pipeline construction. When the HSW technology is applied properly, then it is possible to maintain reject rates below 5%. Less than 5% reject rate is considered a low defect rate.

With respect to the defect shown in FIG. 6, When the HSWs are applied properly with due attention to shielding gas and power source control (including communications with the torch head), then the sizes of the defects can be limited. Flaw height is a particularly important dimension of the defects shown. Height is measured in a direction predominantly perpendicular to the pipe wall surface. HSWs can be applied while maintaining defect height to less than 3 mm, or preferably less than 2 mm, even more preferably less than 1 mm. When the HSWs are optimized to their maximum potential, defect height can be reduced to less than 0.5 mm or evenly eliminated completely.

### Hybrid Laser Arc Welding

The HSWs can be applied using the hybrid laser arc welding (HLAW) process. HLAW welds have high dilution in the lower portions of the weld metal near the root. In this region, the weld metal is mostly remelted base metal. Also, this region of the weld experiences a fast cooling rate. As explained above, dilution calculations can be used to formulate a suitable HSW filler wire for any application, and this includes HLAW of structural steels. Suitable filler wires can be formulated to produce the preferred weld metal chemistry. Low carbon composition weld wires (not greater than about 0.05%, more preferably not greater than 0.03%, and even more preferably not greater than 0.02%) are particularly useful in creating an appropriate metallurgy for HLAWs that achieves excellent combinations of strength and toughness.

### Submerged Arc Welding

It is possible to deploy the HSW metallurgy using the submerged arc welding (SAW) process. One useful application in pipeline construction is that of double-joining pipes in advance of the final laying operation. While it is possible to perform double-joining using the PGMAW techniques mentioned previously, it is more common to use SAW. To accomplish the desired metallurgy with the SAW process, special fluxes are required to optimize the oxygen content of the weld. When SAW welding the HSW metallurgy, oxygen contents must be kept between about 100 and 225 ppm to achieve the SBD-AFIM microstructure. This can be done by controlling the basicity index (BI) of the flux, a term known to those skilled in the art or welding engineering, an index that reflects the basic vs. acidic qualities of the flux and its oxygen removing potential. A number of BI formulas are available, such as the well-known Tuliani formula.

Because the application of double-joining is conducted in the 1G (flat) welding position, this application does not have the weld metal viscosity problems of out-of-position welding. Therefore, the need for advanced power supplies is not as great as for girth welding in the 5G position. It is of course possible to apply the HSW metallurgy to double joint welds using the previously mentioned gas metal arc process; however, SAW has productivity advantages. There exists a tradeoff between the limited position capabilities of SAW and the weld deposition rate. The deposition rate can be relatively high, but out-of-position welding is not possible.

Strain Based Design Engineering Critical Assessment (SBECA) for High Strain Welds

Failure by ductile tearing in SBD applications is a relatively new design scenario for the pipeline industry, and girth welds have not previously been engineered to produce high levels of tearing resistance. The Strain-Based Design Engineering Critical Assessment (SBECA) technology discussed in this application above reinforces the importance of weld toughness for SBD pipelines where higher levels of ductile tearing resistance are useful. This topic is discussed in the following reference: D. P. Fairchild, et al, “Girth Welds for Strain-Based Design Pipelines”, ISOPE Symposium on Strain Based Design, the 18th International Offshore and Polar Eng. Conf, (ISOPE-2008), Vancouver, Canada, Jul. 6-11, 2008, pp. 48-56.

To optimize HSWs for a particular application, a means of designing or selecting the appropriate weld properties is desirable. For SBD pipelines, the following references describe technology on which SBECA can be based and that can be used to relate tolerable weld defect size to such factors as applied loads and material properties: International Patent Application PCT/US2008/001753; K. Minnaar, et al, “Predictive FEA Modeling of Pressurized Full-Scale Tests”, Proceedings of 17th International Offshore and Polar Engineering Conference, Lisbon, Portugal, 2007, pp. 3114-3120; S. Kibey, et al, “Development of a Physics-Based Approach for the Prediction of Strain Capacity of Welded Pipelines”, Proceedings of 19th International Offshore and Polar Engineering Conference, Osaka, Japan, 2009; Kibey, S., et al, “Tensile Strain Capacity Equations for Strain-Based Design of Welded Pipelines”, Proceedings of the 8th International Pipeline Conference, Calgary, Canada (2010), Fairchild, D. P, et al, “A Multi-Tiered Procedure for Engineering Critical Assessment of Strain-Based Design Pipelines”, Proceedings of 21st International Offshore and Polar Engineering Conference, Maui, Hi., 2011. These references explain how the critical defect size in a weld (the largest defect that can be tolerated safely) can be calculated using SBECA technology based on input parameters such as applied loads or strain, the strength properties of the base metal and weldment, the toughness properties of the material in which the defect resides (typically the weld metal or heat affected zone), and the structural geometry. Alternatively, SBECA technology can be used to predict the toughness required to support a weld defect of a given size, given other input parameters such as applied loads, strength properties, and geometric details.

For SBD engineering, several candidate methods exist to measure material toughness including the Charpy V-notch test, the crack tip opening displacement (CTOD) test, the J-Integral method, and the curved wide plate test. Research has shown that it is difficult and/or costly to use these methods to provide a reliable, predictive parameter relating defect size, applied loads, and toughness for predictions of structural performance in SBD scenarios. On the contrary, the SBECA technology above is capable of quantifying and predicting structural performance, and does so by using a toughness parameter called the R-curve. This toughness parameter is measured using a single edge notch tension (SENT) test as is known by those skilled in the art of mechanics of materials. References on R-curve testing include: G. W. Shen, et al, “Measurement of J-R Curves Using Single Specimen Technique on Clamped SE (T) Specimens”, Proceedings of 19th International Offshore and Polar Engineering Conference, Osaka, Japan, pp. 92-99, 2009; W. Cheng, et al, “Test Methods for Characterization of Strain Capacity—Comparison of R-curves from SENT/CWP/FS Tests”, Proceedings of 5th Pipeline Technology Conference, Ostend, Belgium, 2009; H. Tang, et al, “Development of the SENT Test for Strain-Based Design of Welded Pipelines”, Proceedings of 8th International Pipeline Conference, Calgary, Canada, 2010.

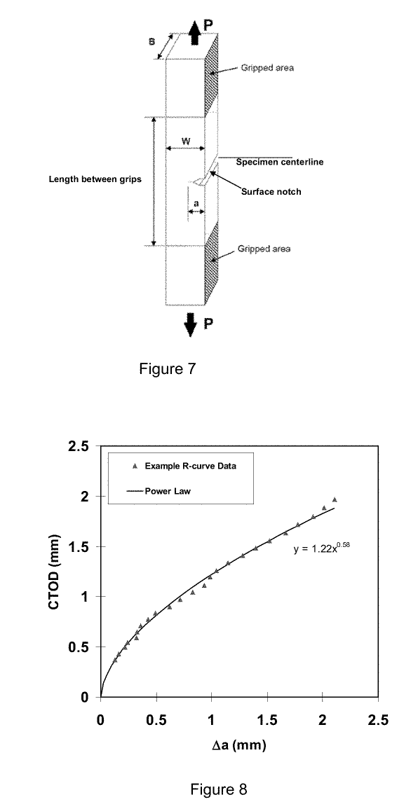

FIG. 7 shows a schematic of a SENT specimen that can be used to measure an R-curve. Other geometries can be used as well. The SENT test specimen geometry is similar to a routine tensile test except that a defect (a crack or notch) is placed at mid-span. The specimen is gripped at gripping areas. The test procedure includes pulling the specimen in tension while monitoring and measuring the progression of defect growth until the specimen can no longer support significant increases in load. One method for generating an R-curve involves repeated loading and unloading of the specimen, where each successive loading cycle imposes increasing loads and (eventually) increasing crack extension. The progression of crack extension can be calculated from the compliance of the specimen, a technique consistent with that described in ASTM E1820 (as described in the 2012 version). This technique is called the unloading compliance method and it can be used to relate crack growth to the applied loads; i.e., the driving force. Any suitable method of crack growth monitoring can be used such as unloading compliance or the potential drop method. The data collected can be used to plot an R-curve graph, which provides a graphical representation of the toughness, or more specifically, the materials resistance to ductile tearing. In other words, the graph characterizes the material's ductile fracture toughness.

While the SBECA technology referred to herein uses SENT testing and R-curves to characterize toughness, other methods can be used to quantify ductile fracture resistance as long as they provide a quantified, predictive ability to relate key parameters such as structural geometry, defect geometry, applied loads and material properties such as strength and toughness properties. One method is to conduct a series of full-scale pipe strain capacity tests, although this approach would be very expensive.

R-curve graphs show the relation between crack extension versus crack driving force. An example R-curve is shown in FIG. 8. As the crack extends, the material's resistance to crack growth (ductile tearing) generally rises. High toughness materials generate R-curves with steep slopes in the initial part of the curve and after the initial rise, the R-curve will continue to rise. The higher the R-curve (larger Y axis values), the higher the toughness. R-curves are sometimes called “delta a” (□a) curves, or J-integral versus □a curves, or CTOD vs. □a curves where the crack driving force is expressed in terms of CTOD or J-integral and is plotted on the y-axis. Crack extension □a (mm) is plotted on the x-axis. The curves can be represented by a mathematical relation such as y=δ·x^{η}, where □ (delta) and □ (eta) are factors in the power law fit of the CTOD (mm) versus □a (mm) plot. According to this description of R-curves and ductile fracture resistance, the R-curves for different weld metals can be compared to judge toughness by considering the CTOD at a crack extension of 1 mm. There are two reasons to select a crack extension of 1 mm for such comparisons. First, when x=1 in the power law equation, the power term reduces to 1 and eta can be ignored. Then, the CTOD is equal to delta and comparisons can be made using only the value of delta. Second, 1 mm of crack growth is a reasonable degree of crack growth to compare toughnesses. According to SBECA knowledge, the strain capacity of pipe girth welds often occurs when crack extensions are on the order of 1 mm. Critical crack extensions can vary from very small values up to 1 mm or 2 mm, depending on many geometry and material property factors, but for the purposes of making general toughness comparisons, the 1 mm convention is adequate.

R-curves of the novel HSW weld metal can generate delta values of more than 0.75 at tensile strengths as high as 150 ksi. With good control of oxygen content or for the lower strength versions of the HSWs, delta values can be greater than 1.00. Depending on application, attention can be focused on optimal welding conditions as disclosed herein and delta values of 1.25 can be achieved or even 1.5 or 1.75. The HSW weld metal can produce these high toughnesses while simultaneously providing high strengths suitable for overmatching X52, X60, X65, X70, X80 or stronger pipe grades for SBD pipelines.

The ability to accurately predict structural performance based on R-curve data and SBECA technology depends on validation of the technique using full-scale pipe strain capacity tests. This is discussed in the following references: International Patent Application PCT/US2008/001676; P. Gioielli, et al, “Large-Scale Testing Methodology to Measure the Influence of Pressure on Tensile Strain Capacity of a Pipeline, Proceedings of 17th International Offshore and Polar Engineering Conference, Lisbon, Portugal, 2007, pp. 3023-3027; P. C. Gioielli, et al, “Characterization of the Stable Tearing During Strain Capacity Tests”, ISOPE Symposium on Strain Based Design, the 18th International Offshore and Polar Eng. Conference, (ISOPE-2008), Vancouver, Canada, Jul. 6-11, 2008, pp. 86-89; X. Wang, et al, “Validation of Strain Capacity Prediction Method—Comparison of Full-Scale Test Results to Predictions from Tearing Analysis Based on FEA”, Proceedings of 5th Pipeline Technology Conference, Ostend, Belgium, 2009. Validation enables relating R-curve data to full-scale performance and this connection provides a calibration basis for parametric development of predictive mathematical expressions for SBECA.

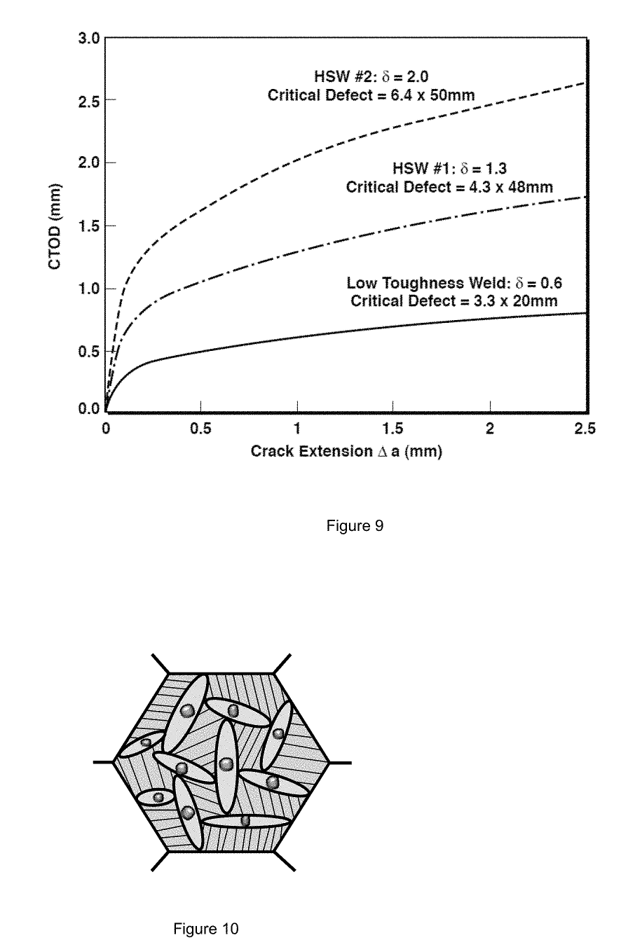

The inventors have used the SBECA technology to quantify the effect of ductile fracture resistance in terms of R-curves for SBD scenarios involving a variety of pipe grades, defect sizes, weld properties, and base metal properties, including consideration of internal pipe pressure and pipe misalignment at the girth welds. A hypothetical example of the results from this work for an X70 girth weld is shown in FIG. 9. This example is for a 42 inch, 20 mm wall pipe with the following longitudinal tensile properties: yield strength of 75 ksi, ultimate tensile strength of 85.2 ksi, and a uniform elongation of 8%. The target strain capacity is 2.5%. Three hypothetical welds are considered, all with 20% UTS (ultimate tensile strength) overmatch and zero millimeters misalignment. For these three welds, the graph displays three different R-curves representing different levels of ductile tearing resistance (all other properties remaining equal). By considering the R-curve values at 1 mm of crack extension, the three curves have delta values of 0.6, 1.3, and 2.0. These levels of tearing resistance represent a relatively low toughness weld (0.6), and two HSWs called HSW #1 and HSW #2. Using the disclosed SBECA technology, critical defects can be calculated for these three R-curves. In terms of defect depth and length in millimeters, the three critical defect sizes associated with the three R-curves are 3.3×20 mm, 4.3×48 mm, and 6.4×50 mm, respectively. As can be seen, higher levels of tearing resistance provide greater defect tolerance. SBECA technology can be used as a design aid to select an optimum set of mechanical properties for HSWs.

HSWs can be designed to produce a range of strengths. Because strength and toughness are inversely related in structural steels, creating higher strength generally means producing lower toughness. For this reason, it is generally not desirable to create any more weld strength than is needed for the application because lower toughness is the tradeoff SBECA technology can be used to design HSWs and optimize the tradeoff between strength and toughness.

### Weld Metal Microstructure

Definitions of metallurgical terms describing the HSW microstructures may be found in the Glossary, while additional details are described in the following three references: (1) N. V. Bangaru, et al, “Microstructural Aspects of High Strength Pipeline Girth Welds,” Proceedings of the 4^{th} International Pipeline Technology Conference, Ostend, Belgium, May 9-13, 2004, pp. 789-808, (2) J. Y. Koo, et al, “Metallurgical Design of Ultra-High Strength Steels for Gas Pipelines,” ISOPE Symposium on High-Performance Materials in Offshore Industry, the 13th International Offshore and Polar Eng. Conference, (ISOPE-2003), Honolulu, Hi., USA, May 25-30, 2003, pp. 10-18, and (3) U.S. Pat. No. 6,565,678. As used herein, predominant or predominantly means at least about 50 volume percent.

In stress-based pipeline design, the microstructure of choice for girth welds is generally acicular ferrite. Furthermore, for high strength pipelines of stress-based design, the microstructure of he '678 Patent is useful. The microstructure of the weld metal of the present disclosure is different from both of these examples. The microstructure of the current invention is comprised of an AFIM microstructure, but the inclusion content is lower than disclosed by the '678 Patent. Whereas the '678 Patent teaches that inclusion number densities of about 5×10¹⁰ m⁻² to 6×10¹⁰ m⁻² are beneficial, the SBD-AFIM weld metal requires less than 4×10¹⁰ m⁻².

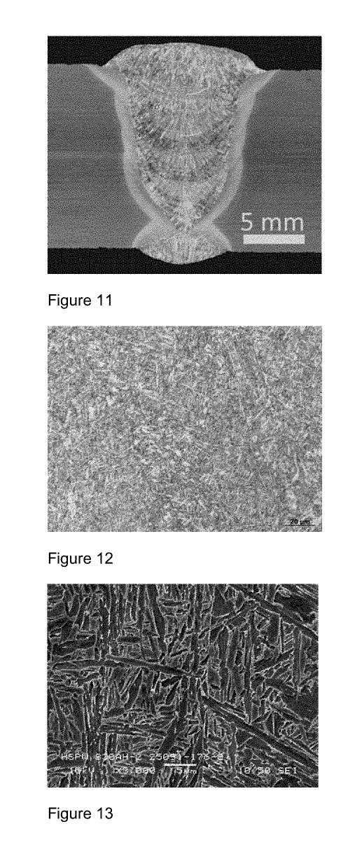

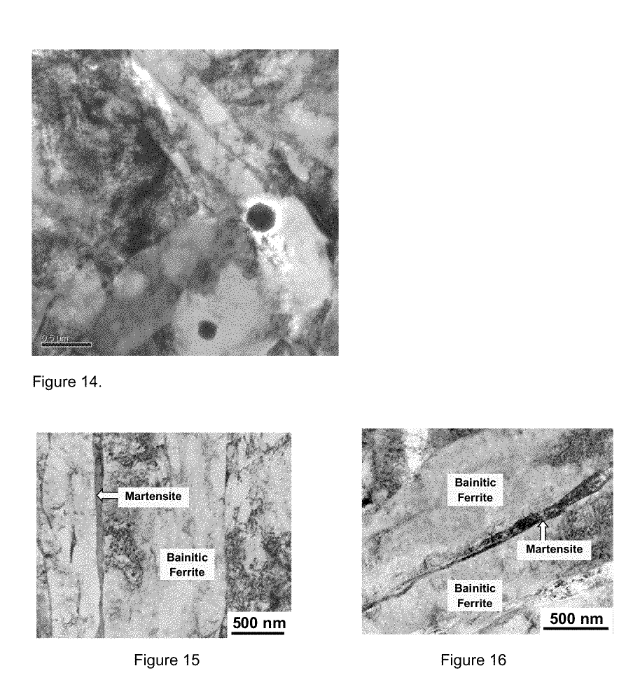

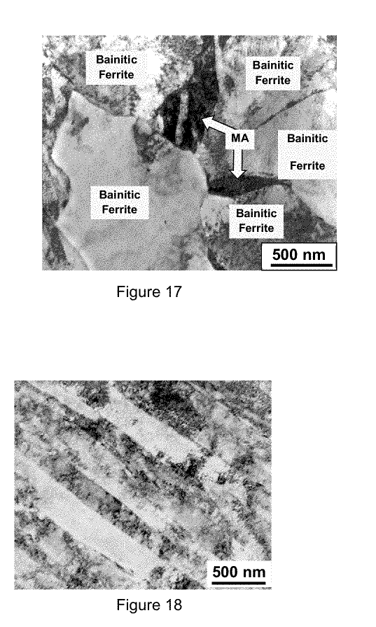

The inventors have studied many variations of AFIM and SBD-AFIM microstructures in detail, and have discovered that the best combination of properties for the intended SBD application is achieved with a balanced proportion of hard constituents and acicular ferrite. A schematic of the SBD-AFIM microstructure is shown in FIG. 10. An example SBD-AFIM weld is shown in FIG. 11. An optical micrograph showing the SBD-AFIM microstructure is shown in FIG. 12. A scanning electron micrograph of the SBD-AFIM microstructure is shown in FIG. 13. A transmission electron micrograph of acicular ferrite is shown in FIG. 14. The hard constituents in SBD-AFIM are predominantly mixtures of lath martensite, lower bainite, degenerate upper bainite, and granular bainite. Transmission electron micrographs of several of these constituents are shown in FIGS. 15-18.

During weld cooling, Ti and Zr based inclusions form in the molten weld metal. These base inclusions are typically further enveloped by spinel shells. As the weld metal cools further, acicular ferrite is nucleated on these inclusions. The remaining austenite then transforms to a mixture of the hard constituents. Typical microstructural balances for SBD-AFIM welds are 15% to 50% acicular ferrite and greater than 50% of the hard constituents. This represents a somewhat higher content of acicular ferrite than described for the typical AFIM welds of the '678 Patent.

### Weld Inspection

The HSWs described herein have advantages related to weld inspection as compared to the welds described in U.S. Patent Application Publication No. US PA 2010/0089463, published Apr. 15, 2010 (International Patent Application PCT/US2008/001409). The HSWs are ferritic whereas the welds of US PA 2010/0089463 are Ni-based welding consumables and they produce austenitic welds which have a face centered cubic (FCC) atomic structure. The ferritic HSWs have a body centered cubic (BCC) atomic structure which is useful in the welding of ferritic pipeline steels (which are also BCC in structure) because it avoids the problem of the dissimilar weld interface that occurs with using high Ni (FCC) welding consumables to weld ferritic pipeline steels. Dissimilar weld interfaces cause difficulties in ultrasonic inspection, as these interfaces produce false signals which can result in unnecessary repairs.

### Examples

The welding wires listed in Table 1 have been made by the inventors for experimentation of SBD-AFIM welds.

TABLE 1
Weld wire chemistries

| Wire | C | Mn | Ni | Mo | Cu | Cr | Si | Ti | Zr | Pcm |
|---|---|---|---|---|---|---|---|---|---|---|
| 1 | 0.035 | 1.81 | 2.94 | 0.58 | 0.12 | 0.08 | 0.610 | 0.014 | 0.027 | 0.244 |
| 2 | 0.045 | 1.86 | 2.98 | 0.57 | 0.30 | 0.16 | 0.600 | 0.014 | 0.024 | 0.269 |
| 3 | 0.065 | 1.9 | 3.07 | 0.59 | 0.16 | 0.20 | 0.390 | 0.014 | 0.040 | 0.282 |

Using wires 1, 2, and 3, several 1G and 5G girth welds were produced using the SBD-AFIM technology disclosed herein. These welds were made on 30 inch diameter, 15.6 mm wall API 5L X80 pipe. This pipe was of the following composition by weight % (wt. %): Carbon: 0.06, Mn: 1.88, Si: 0.25, P: 0.006, S: 0.002, Ni: 0.17, Cu: 0.18, Mo: 0.22, Cr: none, Nb: 0.03, V: none, and Ti: 0.01. The welds were produced using CRC Evans automatic welding equipment which included use of a Fronius TransPulse Synergic 5000 power supply. The CO₂ content of the shielding gas was varied from 0 to 3%. The pulsing parameters were adjusted as disclosed herein, and good weldability was achieved along with excellent mechanical properties. Typical heat inputs in the fill passes of these welds ranged from about 0.45 kJ/mm to 0.70 kJ/mm. Additional details about these welds are given in Tables 2 and 3. The tensile values provided in Table 2 are an average of either two or three tests. The Charpy V-notch (CVN) values in Table 2 are extracted from curve fits to full transition curves whereby each curve was established using approximately 15 individual CVN tests spread across five test temperatures (−60 C, −40 C, −20 C, 0 C, 22 C). The CTOD values given in Table 2 are a minimum of three tests.

TABLE 2
Welding Details and Mechanical Properties

| | | Weld | | | | Yield | | CVN | CTOD |
|---|---|---|---|---|---|---|---|---|---|
| | | Posi- | He | Ar | CO2 | Strength | UTS | (J) @ | (mm) @ |
| Weld | Wire | tion | (%) | (%) | (%) | (ksi) | (ksi) | −20° C. | −20° C. |
| 1 | 1 | 5G | 30 | 70 | 0 | 119 | 131 | 98 | 0.04 |
| 2 | 1 | 5G | 30 | 69 | 1 | 116 | 136 | 143 | 0.08 |
| 3 | 1 | 5G | 30 | 68 | 2 | 121 | 133 | 177 | 0.19 |
| 4 | 1 | 5G | 30 | 67 | 3 | 111 | 129 | 189 | 0.19 |
| 5 | 1 | 1G | 30 | 68 | 2 | 120 | 131 | 162 | 0.34 |
| 6 | 1 | 5G | 10 | 87 | 3 | 127 | 136 | 189 | — |
| 7 | 2 | 5G | 30 | 69 | 1 | 116 | 143 | 124 | 0.11 |
| 8 | 2 | 5G | 30 | 68 | 2 | 116 | 143 | 178 | 0.15 |
| 9 | 3 | 5G | 30 | 69 | 1 | 121 | 146 | 98 | 0.09 |
| 10 | 3 | 5G | 30 | 68 | 2 | 117 | 151 | 156 | 0.14 |

TABLE 3
Weld Metal Chemistries

| | | | | Si | | Mo | Ni | Cu | | | O | |
|---|---|---|---|---|---|---|---|---|---|---|---|---|
| Weld | Wire | C (%) | Mn (%) | (%) | Cr (%) | (%) | (%) | (%) | Ti (%) | Zr (%) | (ppm) | Pcm |
| 1 | 1 | 0.038 | 1.8 | 0.52 | 0.079 | 0.57 | 2.56 | 0.13 | 0.012 | 0.025 | 130 | 0.236 |
| 2 | 1 | 0.034 | 1.78 | 0.53 | 0.079 | 0.57 | 2.61 | 0.13 | 0.011 | 0.024 | 180 | 0.233 |
| 3 | 1 | 0.040 | 1.8 | 0.65 | 0.078 | 0.56 | 2.57 | 0.13 | 0.01 | 0.024 | 180 | 0.242 |
| 4 | 1 | 0.037 | 1.79 | 0.67 | 0.082 | 0.58 | 2.72 | 0.12 | 0.001 | 0.026 | 240 | 0.243 |
| 5 | 1 | 0.046 | 1.85 | 0.51 | 0.081 | 0.55 | 1.82 | 0.15 | 0.011 | 0.026 | 140 | 0.239 |
| 6 | 1 | not | measured | | | | | | | | | |
| 7 | 2 | 0.050 | 1.9 | 0.53 | 0.14 | 0.55 | 2.4 | 0.25 | 0.012 | 0.023 | 110 | 0.259 |
| 8 | 2 | 0.049 | 1.86 | 0.56 | 0.15 | 0.59 | 2.96 | 0.27 | 0.011 | 0.024 | 200 | 0.270 |
| 9 | 3 | 0.057 | 1.92 | 0.48 | 0.19 | 0.61 | 2.9 | 0.17 | 0.012 | 0.037 | 120 | 0.276 |
| 10 | 3 | 0.059 | 1.9 | 0.34 | 0.15 | 0.45 | 2.91 | 0.13 | 0.008 | 0.026 | 160 | 0.258 |

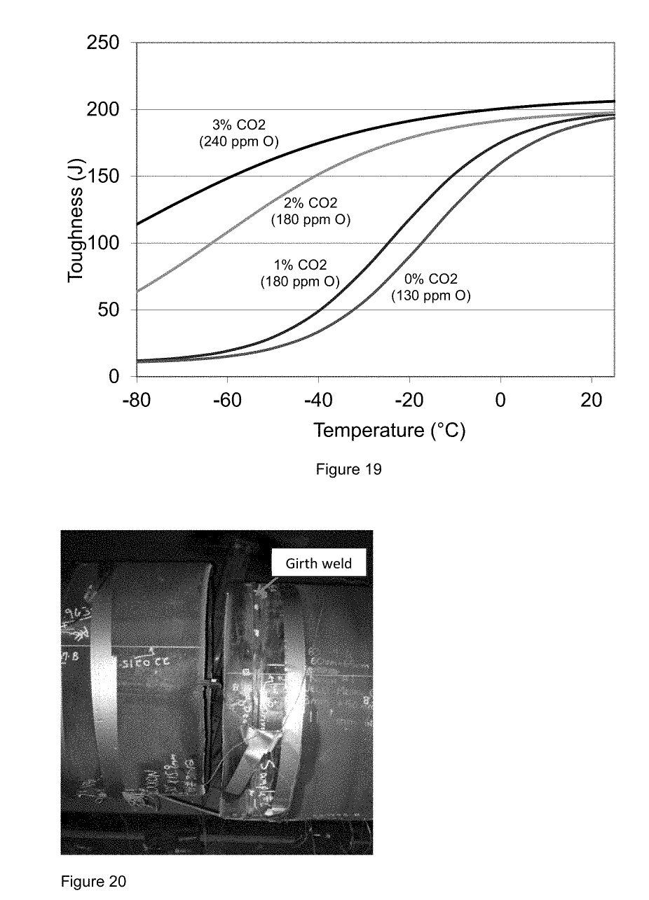

The optimal CO₂ content was found to be approximately 2-3% while lesser CO₂ content showed degraded properties compared to the 2-3% CO₂ welds. The weldability was also found to be optimal with 2-3% CO₂ compared to the welds with less CO₂ content. Welds number 1 through 4 are a good example of the effect of CO₂ content in the shielding gas. As the CO₂ content increased in order 0%, 1%, 2%, and 3%, the CVN value at −20 C changed in order 98J, 143J, 177J, and 189J, respectively. This trend is shown in FIG. 19 where the ductile-to-brittle transition temperature decreases as the CO₂ content increased from 0% to 3%. It is noted that the oxygen content of welds 2 and 3 (with CO₂ contents 1% and 2%, respectively) are the same at 180 ppm. It would normally be expected that the lower CO₂ content weld would generate a lower oxygen content; however, as is known to those skilled in the art of welding metallurgy, scatter in weld metal oxygen content measurements is quite common. Nevertheless, the overall trend in the data shown in Tables 2 and 3 demonstrates a novel aspect of the SBD-AFIM disclosed herein.

Welds 1 through 4 show that as CO₂ content increases from 0% to 3%, CTOD increases. Specifically, as the CO₂ content increased in order 0%, 1%, 2%, and 3%, the CTOD values changed in order 0.04 mm, 0.08 mm, 0.19 mm, and 0.19 mm, respectively.

The weld pair 7 & 8 and the weld pair 9 & 10 demonstrate the aforementioned toughness trend. Namely, as CO₂ content in the gas increased from 1% to 2%, both of these example pairs (with different weld wires) show that toughness increases. Both CVN and CTOD toughness increased. The weld metal oxygen content data for these pairs is consistent with the stated trend whereby oxygen increases as CO₂ content increases. The trend in oxygen content requires explanation. Conventional thinking states that as oxygen content increases, weld metal toughness decreases. This is generally true, but as the details of the present disclosure show, and within the relevant range of CO₂ content for SBD-AFIM (less than 5%), there are two competing factors. Decrease in CO₂ content leads to decreased weld metal oxygen and generally this would increase toughness, but for the SBD-AFIM welds there is a competing effect of acicular ferrite nucleation. When the weld metal oxygen content becomes too low, acicular ferrite nucleation is stifled and toughness decreases. Therefore, it is demonstrated that an optimal tradeoff exists between the competing factors and 2-3% CO₂ content in the shielding gas is the best balance.

A full-scale pipe strain test was conducted using 30 inch diameter, 15.6 mm wall thickness X80 pipe. The specimen contained two girth welds made using the welding scenario described as weld 3 in Table 2. The full-scale specimen was pre-populated with a total of four 3×50 mm defects; two in each girth weld. The defects were machined from the OD (outside diameter) and were placed in both the weld metal and heat affected zone. The girth welds were produced with up to 3 mm of high-low misalignment and the defects were placed in the location of maximum misalignment. A companion girth weld was produced and used for property measurement. The yield and ultimate strength of the weld metal was 119 ksi and 130 ksi, respectively. The CVN toughness at −20 C was 179J. Three CTOD tests at −20 C produced values of 0.18 mm, 0.30 mm and 0.25 mm. Several SENT tests produced an average R-curve delta value of 1.25. The full-sale test was pressurized to 72% of the specified minimum yield strength and pulled in tension to failure. This test was conducted as explained in the previously cited references on full-scale pipe strain testing. The test achieved 3.2% strain before the specimen failed in the pipe body away from the weld. A photo of the failure location is shown in FIG. 20.

As demonstrated by these examples, HSWs are useful in producing pipeline girth welds capable of achieving high toughnesses and high levels of applied strain even when containing common welding defects. HSWs can be made with tensile strengths as high as 100 ksi, 110 ksi, 120 ksi, more preferably 130 ksi, and even more preferably 140 ksi. These welds can produce good brittle fracture resistance as evidenced by weld metal CTOD values above 0.10 mm at temperatures of −20° C. for welds made using optimized conditions. With attention paid to chemistry, oxygen content, and microstructure, HSWs can produce this strength and toughness at temperatures as low as −10° C., −15° C., −20° C., or even −30° C. or −40° C.

Another useful measure of toughness is the ductile-to-brittle transition temperature, a common parameter known to those skilled in the art of welding metallurgy and structural design. This transition temperature can be determined using any number of tests including the Charpy V-notch (CVN) test. The CVN transition temperature can based on either Charpy energy or shear area and generally refers to the middle or mid-point of the toughness transition curve on a graph of Charpy toughness versus test temperature. The transition temperature of HSWs as measured by the CVN test can be made to produce ductile-to-brittle transition temperatures down to −20° C., −30° C., or −40° C. With attention paid to chemistry, oxygen content, and microstructure, transition temperatures as low as −60° C. or −80° C. can be achieved. The upper shelf energies produced by the HSWs can be 100J, more preferably 125J, even more preferably 150J. If the HSW is designed with optimized levels of oxygen and acicular ferrite content, then upper shelf energies of 175J can be achieved.

With respect to ductile fracture resistance, the HSWs can produce R-curves as high or higher than described by a curve where at a crack extension of 1 mm the delta value is at least 0.75. With attention paid to chemistry, oxygen content and microstructure, HSWs can produce R-curves as high or higher than a curve with a delta value of 1.0, preferably 1.25, and even higher than 1.5.

With the above described mechanical properties, the HSW girth welds can achieve global plastic strains greater than 0.5% while containing typical weld defects of sizes such as 2×25 mm, 3×50 mm, 4×50 mm, or 5×50 mm, or 6×50 mm, depending on wall thickness. The first dimension of these defects describes the flaw height in a direction perpendicular to the pipe surface and the second dimension (the larger dimension) is the flaw length along the hoop direction of the girth weld. Even long defects such as 3×100, 2×100 mm or 1×200 mm can be supported while achieving plastic strains larger than 0.5%. Depending on defect size and pipe wall thickness, global plastic strains of 1%, 1.5%, 2%, 2.5%, 3% or even 4% or 5% can be achieved. High strain capacities can be achieved in pipe grades up to about X120.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

### Glossary

Austenitic alloys: any of a group of engineering alloys such as stainless steel, Ni-based alloys, and duplex stainless steels that possess an austenitic microstructure characterized by a face centered cubic (fcc) atomic arrangement.

Ferritic alloys: any of a group of engineering alloys that possess a ferritic microstructure characterized by a predominantly body centered cubic (bcc) atomic arrangement.

Yield strength: That strength corresponding to a departure from linear elastic behavior where load support is achieved without permanent deformation and plastic behavior where load support results in measurable permanent deformation.

Tensile strength: That strength corresponding to the maximum load carrying capability of the material in units of stress when the failure mechanism is not linear elastic fracture.

HAZ: Heat-affected-zone.

Pcm: A formula used to quantify hardenability based on the wt % of common alloying elements used in steel. Hardenability is the degree to which a steel transforms to martensite (a hard microstructure) when cooled from high temperatures.

Pcm=C+Si/30+(Mn+Cu+Cr)/20+Ni/60+Mo/15+V/10+5B.

The alloy content in wt. % is entered into the equation to calculate the Pcm number.

Heat-affected-zone: Base metal that is adjacent to the weld fusion line, is not melted during the welding operation, but that was affected by the heat of welding.

Toughness: Resistance to fracture.

Weldment: An assembly of component parts joined by welding.

Weld bead penetration profile: The shape of the weld bead near the bottom (root) of the weld bead when observed in a transverse cross-section.

Weldability: The feasibility of welding a particular metal or alloy. Sometimes weldability refers to the susceptibility of hydrogen induced cracking during welding, but in the context of this disclosure, weldability refers to the ease of welding without creating defects such as lack of fusion, lack of penetration, or undercut. A number of factors contribute to poor weldability including a high surface tension molten weld pool and an erratic or unstable welding arc. These factors create symptoms observed by the welder including poor wetting of the weld pool into the adjacent base metal, sharp (or small) reentrant angles at the weld toes, undesirable weld spatter. Obtaining good weldability refers to a group of attributes including good weld pool fluidity, arc stability (“smooth” arc), good wetting of the weld pool at the junction with the base metal, good bead penetration geometry all of which are aimed at reducing weld defects.

Gas metal arc welding (GMAW): A welding process that utilizes a torch whereby the filler wire acts as the electrode, is automatically feed through a contact tip, and is consumed in the welding process. The contact tip is typically surrounded by a gas cup that directs shielding gas to the area of the welding arc. Common shielding gases are argon, CO2, helium, and oxygen. Torch travel can be provided by a machine (automatic or mechanized) or can be provided by a human (semiautomatic). The process name GMAW is a standard designation made by the American Welding Society.

Pulsed gas metal arc welding (PGMAW): A variation of the GMAW process that utilizes power sources that provide current pulsing capabilities. These are sometimes referred to as advanced current waveform power sources. The American Welding Society has termed PGMAW as GMAW-P.

GMAW-based processes: A number of allied processes similar to GMAW such as PGMAW, metal core arc welding (MCAW), and flux cored arc welding (FCAW). The primary difference with MCAW is that a cored wire is used and there exists metal powders within the core. The FCAW process also uses a cored wire and the core typically consists of flux powders. FCAW can be used with or without shielding gas.

Gas tungsten arc welding (GTAW): A welding process that utilizes a torch whereby the electrode is a non-consumable tungsten rod. The process can be performed with or without a filler wire. If without a filler wire, the process is referred to as autogenous. If a filler wire is used, it is fed from the side (as opposed to through the torch centerline as with the many other processes like GMAW) into the weld pool/arc region. Filler wire feed can be provided by a machine or by a human. Weld torch travel can be provided by a machine or by a human. The tungsten electrode is surrounded by a gas cup that directs shielding gas to the weld pool/arc region. Typical shielding gases include argon and helium.

Hybrid-laser arc welding (HLAW): A process that combines laser welding and GMAW. Typically the laser precedes the GMAW arc to provide deep penetration. The GMAW component of HLAW creates the ability to accommodate larger variations in joint fit up as compared to laser welding alone. Whereas a laser can only bridge gaps of very narrow widths (˜1 mm), GMAW welding can bridge gaps of several millimeters.

Submerged arc welding (SAW): A welding process that requires a continuously fed consumable solid or tubular (flux cored) electrode. The molten weld and the arc zone are protected from atmospheric contamination by being “submerged” under a blanket of granular fusible flux.

Low oxygen welding environment: A welding process whereby the protection afforded to the molten weld pool achieves a weld metal oxygen content of less than about 200 ppm oxygen. The protection can be achieved by use of a shielding gas or a flux.

Proeutectoid ferrite (PF): In reference to steel weld microstructures, this phase is also called polygonal ferrite and grain boundary ferrite. PF tends to be one of the first; if not the first phase to transform from the austenite as the weld metal cools from high temperatures. Nucleation occurs at the prior austenite grain boundaries; therefore the PF grains are located on these boundaries. The grains can take on a polygonal shape or sometimes sideplates will form from the allotriomorphs which then defines a related phase called Widmanstatten ferrite.

Acicular ferrite (AF): AF is often the first decomposition product to transform in a steel weld from the austenite during cooling, although proeutectoid ferrite (polygonal ferrite) can sometimes form first. AF nucleates on small, non-metallic inclusions and then experiences rapid growth by a bainitic-type transformation mechanism. The AF grains typically exhibit a needle-like morphology with aspect ratios ranging from about 2:1 to 20:1 depending on cooling rate and chemistry. This transformation involves both shear and diffusional components. The transformation temperature controls the interplay between the diffusional and shear components, thus determining AF morphology.

Granular bainite (GB): Refers to a cluster of 3 to 5 relatively equiaxed bainitic ferrite grains that surround a centrally located, small “island” of Martensite Austenite (MA). Typical “grain” diameters are about 1-2 μm.

Upper bainite (UB): Refers to a mixture of acicular or laths of bainitic ferrite interspersed with stringers or films of carbide phase such as cementite. It is most common in steels with carbon contents higher than about 0.15 wt %.

Degenerate upper bainite (DUB): A bainitic product where each colony grows by shear stress into a set (packet) of parallel laths. During and immediately after lath growth, some carbon is rejected into the interlath austenite. Due to the relatively low carbon content, carbon enrichment of the entrapped austenite is not sufficient to trigger cementite plate nucleation. Such nucleation does occur in medium and higher carbon steels resulting in the formation of classical upper bainite (UB). The lower carbon enrichment at the interlath austenite in DUB results in formation of martensite or martensite-austenite (MA) mixture or can be retained as retained austenite (RA). DUB can be confused with classical upper bainite (UB). UB of the type first identified in medium carbon steels decades ago consists of two key features; (1) sets of parallel laths that grow in packets, and (2) cementite films at the lath boundaries. UB is similar to DUB in that both contain packets of parallel laths; however, the key difference is in the interlath material. When the carbon content is about 0.15-0.40, cementite (Fe3C) can form between the laths. These “films” can be relatively continuous as compared to the intermittent MA in DUB. For low carbon steels, interlath cementite does not form; rather the remaining austenite terminates as MA, martensite, RA, or mixtures thereof.

Lower bainite (LB): LB has packets of parallel laths similar to DUB. LB also includes small, intra-lath carbide precipitates. These plate-like particles consistently precipitate on a single crystallographic variant that is oriented at approximately 55° from the primary lath growth direction (long dimension of the lath).

Lath martensite (LM): LM appears as packets of thin parallel laths. Lath width is typically less than about 0.5 Untempered colonies of martensitic laths are characterized as carbide free, whereas auto-tempered LM displays intra-lath carbide precipitates. The intralath carbides in autotempered LM form on more than one crystallographic variant, such as on <110> planes of martensite. Often the cementite is not aligned along one direction; rather it precipitates on multiple planes.

Tempered martensite (TM): TM refers to the heat treated form of martensite in steels whereby the heat treatment is performed in furnace or by local means such as using heating wrap. This form of tempering is conducted after welding fabrication. The microstructure and mechanical properties change as the metastable structure martensite incurs the precipitation of cementite during excursions in a temperature range where cementite precipitation is possible, but too low for austenite formation.

Auto-tempered lath martensite: martensite that incurs self-tempering during cooling from an operation such as welding. Cementite precipitation occurs in-situ, on cooling, and without reheating as is done for traditional tempering.

Twinned Martensite (TwM): This version of martensite forms due to a higher carbon content compared to chemistries that contains mostly lath martensite. TwM forms when the carbon content is above about 0.35% to 0.44%. Below this carbon level, lath martensite is predominant. TwM contains internal twins that have formed to accommodate transformation deformations and stresses. Typical structural steels do not contain high carbon contents; therefore, TwM in structural steels (particularly welds) is mostly found in regions of chemical segregation. Segregation can create local areas of high carbon concentration, thus leading to TwM. This is often the case in areas of MA in welds and heat affected zones.

Martensite austenite constituent (MA): Remnant areas of microstructure in a ferritic steel or weld that transform on cooling to a mixture of martensite and retained austenite. These areas are often the last regions to transform on cooling. MA regions are stabilized due to carbon rejection from surrounding areas that have already transformed at higher temperatures. Due to stabilization, the transformation of austenite to MA occurs at lower temperatures than the surrounding areas. Regions of MA are typically dominated by martensite while only containing small volume fractions of retained austenite (less than 10%). MA is often seen on prior austenite grain boundaries of welds or HAZs that experience double thermal cycles. MA is also found on lath boundaries in the lath based microstructures of degenerate upper bainite and lower bainite. MA is typically observed on any number of lath, packet or grain boundaries present in structural steels.

Retained Austenite: Austenite that remains in the steel microstructure after cooling to room temperature. Austenite is stable at high temperatures, but once the microstructure cools below the A3 and A1 temperatures, lower temperature transformation products, such as ferrite, bainite and martensite, become stable and form from the austenite. Depending on cooling rate and chemistry, some small areas of the microstructure can become enriched in alloys (mostly carbon) and they remain stable and present at room temperature.

Engineering Critical Assessment (ECA): Methods for designing, qualifying, or otherwise assessing the structural significance of material defects, such as cracks or weld defects. One goal is to prevent structural failure. Another goal is prevent unnecessary repairs when the defects are analyzed to be benign. ECA methods are often based on fracture mechanics technology. ECA methods are capable of defining the critical conditions for failure based on, generally, three inputs: material properties, applied loads, and defect size. ECA is often used to predict the critical value of one parameter based on input of the other two. Other names for ECA methods include defect assessment procedures and fitness-for-purpose analysis.

Strain Based Engineering Critical Assessment (SBECA): Methods to determine the flaw tolerance of pipeline girth welds to applied tensile strains. This may mean characterizing ductile fracture resistance by experiments and then calculating acceptable flaw sizes based on a target strain demand. Alternatively, a target strain demand and flaw size can be used to calculate required ductile fracture resistance. SBECA requires knowledge or assumptions regarding several material properties including yield and tensile strengths. Often assumptions are necessary regarding the accuracy of non-destructive inspection techniques.

Critical defect size: Reference to a material defect, such as a crack or weld defect, in an engineering structure where this defect is the smallest defect that will cause failure depending on the specifics of pipe and weld mechanical properties, defect geometry, structural geometry, and applied loads. This term is commonly used when discussing engineering critical assessment (ECA).

High-Low Misalignment: the degree of geometric offset between adjacent pipe pieces at a girth weld. Misalignment varies around the pipe circumference. While best efforts are made to minimize misalignment, the magnitude of high-low can be fractions of a millimeter up to several millimeters. 1 mm of high-low would be considered small for large diameter pipe (say, for >24″ diameter pipe), while >3 mm of high-low would be considered large. High-low misalignment rarely exceeds about 5 mm.

1.-22. (canceled)

23. A method of welding ferritic steel pipelines comprising:
determining a desired HSW weld metal chemistry comprising between 0.03 and 0.08 wt % carbon, between 2.0 and 3.5 wt % nickel, not greater than about 2.0 wt % manganese, not greater than about 0.80 wt % molybdenum, not greater than about 0.70 wt % silicon, not greater than about 0.03 wt % aluminum, not greater than 0.02 wt % titanium, not greater than 0.04 wt % zirconium, between 100 and 225 ppm oxygen, not greater than about 100 ppm nitrogen, not greater than about 100 ppm sulfur, not greater than about 100 ppm phosphorus, and the balance iron;
determining and providing a welding consumable wire chemistry from a calculation using as inputs dilution percent, a pipeline base metal chemistry, and the desired HSW weld metal chemistry; and
girth welding the pipeline base metal using the welding consumable wire to produce a weld metal, the girth welding process comprising:
applying the girth welding using a gas metal arc welding process using a shielding gas with less than 5 vol % CO₂ and less than 2 vol % O₂, and
using an advanced pulsed waveform power supply constructed and controlled to mitigate the negative weldability aspects of using a shielding gas with less than 5 vol % CO₂,
wherein the weld metal achieves a target weld metal oxygen content that is not greater than about 225 ppm oxygen and a weld metal inclusion population not greater than 4×10¹⁰ m⁻², the weld has an SBD-AFIM microstructure, a tensile strength of greater than 90 ksi and a SENT R-curve delta value of greater than 0.75.

24. The method of claim 23, wherein the shielding gas comprises a mixture of less than 5 vol % CO₂, helium, and argon in the amount of at least 50 volume percent.

25. The method of claim 23, wherein the shielding gas comprises a mixture of less than 5 vol % CO₂, at least 10 vol % helium, and argon in the amount of at least 50 volume percent.

26. The welding method of claim 23, wherein the shielding gas comprises a mixture of less than 5 vol % CO₂ and the balance being argon.

27. The method of claim 23, wherein the step of girth welding further comprises using a hybrid laser arc welding process.

28. The method of claim 23, wherein the step of girth welding further comprises using a submerged arc welding process.
